(19) United States
(12) Patent Application Publication
(10) Pub. No.: US 2013/0051036 A1
(43) Pub. Date: Feb. 28, 2013

(54) LED LAMP

(71) Applicants: Tsutomu Totani, Aichi (JP); Nanako Mizuta, Aichi (JP)

(72) Inventors: Tsutomu Totani, Aichi (JP); Nanako Mizuta, Aichi (JP)

(73) Assignee: Beat-Sonic Co., Ltd., Nisshin-shi (JP)

(21) Appl. No.: 13/562,581

(22) Filed: Jul. 31, 2012

(30) Foreign Application Priority Data
Aug. 29, 2011 (JP) P2011-185525

(51) Int. Cl. F21V 29/00

(52) U.S. Cl. 362/373

(57) ABSTRACT

An LED lamp includes a heat dissipater having two ends, a module substrate fixed to one end of the heat dissipater and mounted with an LED chip, a cap mounted on the other end side of the heat dissipater, a lighting circuit provided between the module substrate and the cap to supply electric power to the LED chip, the lighting circuit being electrically connected to the cap, and a cylindrical member which is interposed between the heat dissipater and the cap and is flexible so that the heat dissipater is tiltable relative to the cap.

### CROSS-REFERENCE TO RELATED APPLICATIONS

This application is based upon and claims the benefit of priority from the prior Japanese Patent Application No. 2011-185525 filed on Aug. 29, 2011, the entire contents of both of which are incorporated herein by reference.

### BACKGROUND

1. Technical Field

The present disclosure relates to an LED lamp incorporating an LED chip serving as a light source.

2. Related Art

Demand for LED lamps or LED light bulbs has recently been increasing as substitute for incandescent lamps having higher electrical power consumption. The LED lamps have far less power consumption. One type of LED lamp includes a metal heat dissipator made of a metal, such as aluminum, having high heat conductivity, a cap mounted on one end of the heat dissipator, a glove comprising a light-transmissive glass or plastic material having a semi-spherical top and attached to the other end of the heat dissipator, a module substrate on which an LED chip is mounted and a lighting circuit supplying electrical power to the LED chip. The module substrate and the lighting circuit are mounted on the heat dissipator, and the LED chip is caped by the glove. The lighting circuit and the cap are electrically connected to each other. This type of LED lamp is disclosed by Japanese Patent Application Publication Nos. JP-A-2011-70972,JP-A-2011-82132, JP-A-2011-90828 and JP-A-2011-91033.

Light emitted by a filament serving as a light source for an incandescent lamp is diffused around thereby to evenly illuminate the surrounding area. On the other hand, light emitted by the LED chip used as a light source for an LED lamp has a high directionality and accordingly has a characteristic of illuminating a frontward narrow region by intense light.

Furthermore, the temperature of the filament of the incandescent lamp sometimes rises up to 2,000° C. during turn-on. As a result, the surface of the glove covering the filament is heated thereby to have a high temperature such that touch or contact to the glove surface would result in burn injury.

On the other hand, the LED chip serving as the light source for the LED lamp has an exceedingly lower calorific value during turn-on as compared with the filament. Accordingly, even the temperature of the heat dissipator rises to about several dozen degrees at the highest during turn-on. The glove has such a characteristic that the temperature thereof is so low that the glove can be touched during turn-on as compared with the incandescent lamp.

### SUMMARY

An object of the disclosure is to provide an LED lamp which can provide new use applications by making use of high directivity and low heat dissipation of the LED chip serving as the light source thereof.

The present disclosure provides an LED lamp comprising a heat dissipator having two ends, a module substrate fixed to one end of the heat dissipator and mounted with an LED chip, a cap mounted on the other end side of the heat dissipator, a lighting circuit provided between the module substrate and the cap to supply electric power to the LED chip, the lighting circuit being electrically connected to the cap, and a cylindrical member which is interposed between the heat dissipator and the cap and is flexible so that the heat dissipator is tiltable relative to the cap.

The heat dissipator can be tilted relative to the cap by the flexible cylindrical member. Consequently, the irradiation direction of the LED chip fixed to the heat dissipator can be changed.

When an electrical lamp with directionality is mounted to a socket of the downlight installed on a ceiling, the irradiation direction of the lamp cannot be changed since the socket is fixed to the ceiling. In the above-described construction, however, the irradiation direction of the LED lamp can be changed by the flexure of the cylindrical member even when the LED lamp is mounted to the socket fixed to the ceiling.

The disclosure also provides an LED lamp comprising a heat dissipator having two ends, a module substrate fixed to one end of the heat dissipator and mounted with an LED chip, a cap mounted on the other end side of the heat dissipator, a lighting circuit provided between the module substrate and the cap to supply electric power to the LED chip, the lighting circuit being electrically connected to the cap, and a cylindrical member which is interposed between the heat dissipator and the cap and is extendable so that the heat dissipator is capable of advancing or retreating relative to the cap.

When the LED lamp is mounted to the socket of the downlight installed on the ceiling or the socket of lighting equipment installed on a wall, the cylindrical member is extended thereby to increase the lamp length. Consequently, a mounting work of the LED lamp can be rendered easier. Furthermore, the lamp length is reduced by contracting the cylindrical member after the LED lamp has been mounted to the socket. This can reduce projecting dimensions of the LED lamp from the socket.

In one embodiment, the lighting circuit is disposed internally in the cylindrical member. Thus, since the cylindrical member is used as an installation space for the lighting circuit, the LED lamp can be rendered smaller in size.

In another embodiment, the cylindrical member includes a middle portion formed with bellows and has two ends one of which is connected to the heat dissipator and the other of which is connected to the cap. The irradiation direction of the LED lamp can be changed by flexing the bellows. Furthermore, the lamp length can be increased or reduced by flexing the bellows.

In further another embodiment, the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions. The connection between the large-diameter cylindrical portion and the tapered ring surface is formed with a first flexible portion, and the connection between the smaller-diameter cylindrical portion and the tapered ring surface is formed with a second flexible portion. The tapered ring surface is flexed at the flexible portion relative to the larger-diameter and smaller-diameter cylindrical portions thereby to be selectively maintained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

In the above-described construction, the lamp length can be increased by retaining the tapered ring surface at the extended position, and the LED lamp can be maintained in a state where the lamp length thereof is increased. Furthermore, the lamp length can be reduced by retaining the tapered ring surface at the contracted position, and the LED lamp can be maintained in a state where the lamp length is reduced. Still furthermore, when the tapered ring surface is retained at the flexed position, the heat dissipator can be tilted, whereupon the irradiation direction of the LED lamp can be changed, and the LED lamp can be maintained in a state where the tapered ring surface is in the flexed position.

In further another embodiment, the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions. The tapered ring surface is formed with a plurality of though holes or slits. The tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

In this construction, the lamp length can also be increased by retaining the tapered ring surface at the extended position. The lamp length can also be reduced by retaining the tapered ring surface at the contracted position. Furthermore, when the tapered ring surface is retained at the flexed position, the heat dissipator can also be tilted, whereupon the irradiation direction of the LED lamp can be changed.

### BRIEF DESCRIPTION OF THE DRAWINGS

In the accompanying drawings:

FIG. 1 is a sectional view of the LED lamp of a first embodiment;

FIG. 2 is a sectional view of the LED lamp of the first embodiment with a heat dissipater being tilted;

FIG. 3 is a sectional view of the LED lamp of a second embodiment;

FIG. 4 is a perspective view of the LED lamp of the second embodiment;

FIG. 5 is a partially enlarged view of a tapered ring surface of the LED lamp of the second embodiment;

FIG. 6 is a sectional view of the LED lamp of the second embodiment with the lamp length being reduced;

FIG. 7 is a sectional view of the LED lamp of the second embodiment with the heat dissipater being tilted;

FIG. 8 is a perspective view of the LED lamp of a third embodiment;

FIG. 9 is a perspective view of the LED lamp of a fourth embodiment;

FIG. 10 is a perspective view of the LED lamp of a fifth embodiment;

FIG. 11 is a perspective view of the LED lamp of a sixth embodiment;

FIG. 12 is a sectional view of the LED lamp of the sixth embodiment with the lamp length being reduced;

FIG. 13 is a sectional view of the LED lamp of a seventh embodiment;

FIG. 14 is a perspective view of the LED lamp of the seventh embodiment;

FIG. 15 is a partially enlarged view of the tapered ring surface of the LED lamp of the seventh embodiment;

FIG. 16 is a sectional view of the LED lamp of the seventh embodiment with the lamp length being reduced;

FIG. 17 is a sectional view of the LED lamp of the seventh embodiment with the heat dissipater being tilted;

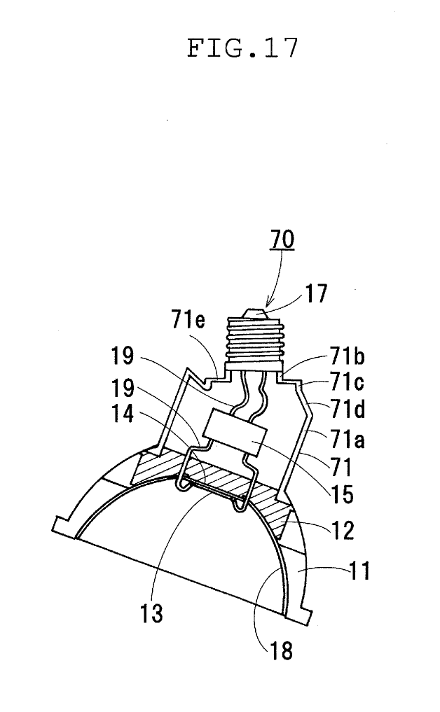

FIG. 18 is a sectional view of the LED lamp of an eighth embodiment;

FIG. 19 is a partially enlarged view of the first tapered ring surface of the LED lamp of the eighth embodiment;

FIG. 20 is a sectional view of the LED lamp of the eighth embodiment with the lamp length being reduced;

FIG. 21 is a sectional view of the LED lamp of the eighth embodiment with the heat dissipater being tilted;

FIG. 22 is a sectional view of the LED lamp of a ninth embodiment;

FIG. 23 is a sectional view of the LED lamp of the ninth embodiment with the lamp length being reduced; and

FIG. 24 is a sectional view of the LED lamp of the ninth embodiment with the heat dissipater being tilted.

### DETAILED DESCRIPTION

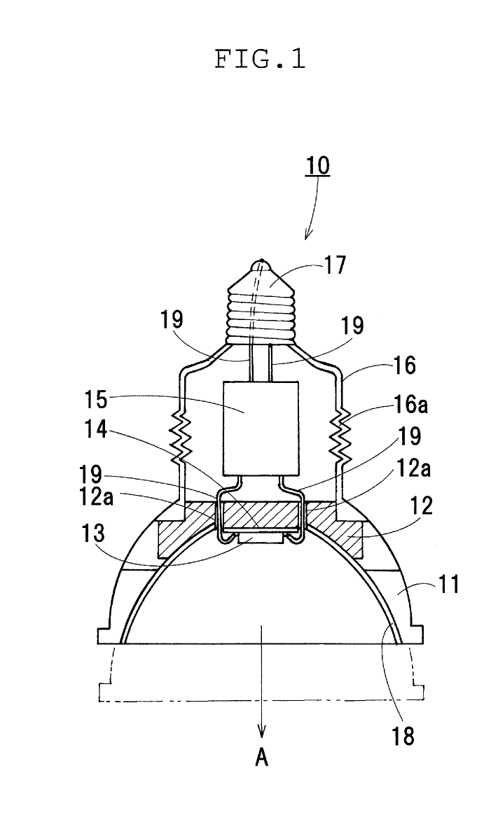

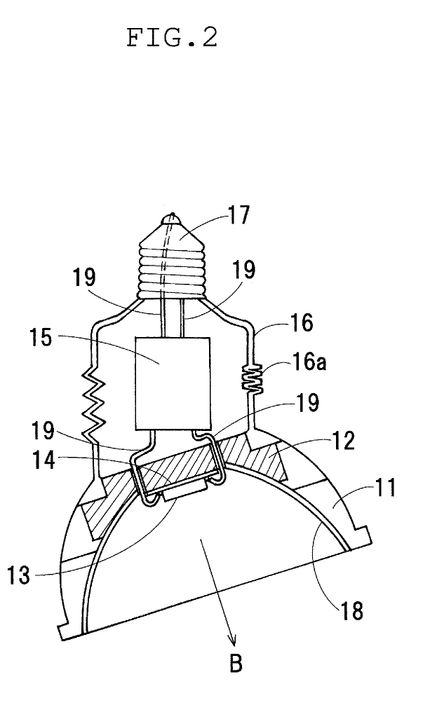

Several embodiments will be described with reference to the accompanying drawings. Referring to FIGS. 1 and 2, an LED lamp 10 of a first embodiment is shown. The LED lamp 10 includes a resin cap 11, a heat dissipater 12 formed of a metal such as aluminum with good heat conductivity and high radiation performance, a module substrate 14 mounted with an LED chip 13, a lighting circuit 15 supplying electric power to the LED chip 13, a cylindrical member 16 and a cap 17 having a shape and dimensions according to the International Standard.

The heat dissipater 12 is formed into a generally flat dish shape and has an inner end surface including a central part to which the module substrate 14 is fixed. The heat dissipater 12 has an outer periphery to which the cap 11 is attached. The cap 11 has an inner peripheral surface formed with a generally paraboloidal mirror surface 18. The cylindrical member 16 has two end one of which is attached to the outer periphery of the heat dissipater 12. The cap 17 is attached to the other end of the cylindrical member 16. The cylindrical member 16 is formed of plastic and has a middle part formed with bellows 16a.

The lighting circuit 15 is disposed internally in the cylindrical member 16. The heat dissipater 12 is formed with a through hole 12a through which extends a lead wire 19 connecting between the LED chip 13 and the lighting circuit 15. The lighting circuit 15 is further connected to the cap 17 by another lead wire 19.

The cap 17 of the LED lamp 10 configured as described above is screwed into a socket of lighting equipment mounted on a wall or a socket of a downlight mounted on a ceiling, so that the LED lamp 10 is mounted. Then, electric power is supplied to the lighting circuit 15, from which the electric power is further supplied to the LED chip 13, with the result that the LED chip 13 emits light. Consequently, the LED lamp 10 emits light in a direction of arrow A in FIG. 1.

Even when turned on, the LED lamp 10 is not heated to a high temperature as an incandescent lamp, the user can touch the cap 11 by his/her hand. When the cap 11 is manually pulled downward, the cylindrical member 16 is expanded at the bellows 16a relative to the cap 17 screwed into the socket, whereby the lamp length of the LED lamp 10 is increased as shown by two-dot chain line in FIG. 1. Furthermore, when the cap 11 is manually pushed upward, the bellows of the cylindrical member 16 is contracted, whereby the lamp length is reduced.

According to the above-described embodiment, the cylindrical member 16 is expanded with the result of increased lamp length when the LED lamp 10 is mounted to the socket of the downlight or to the socket of the lighting equipment installed on the wall surface. This can render the mounting work easier. Furthermore, the cylindrical member 16 is contracted such that the lamp length is reduced after the LED lamp 10 has been mounted to the socket, whereupon a projecting dimension of the LED lamp 10 from the socket can be reduced.

Furthermore, when cap 11 is manually pushed or pulled rightward, the cylindrical member 16 is flexed at the bellows 16a as shown in FIG. 2. Accordingly, the heat dissipater 12 can be tilted relative to the cap 17 screwed into the socket. This can change the irradiation direction from the direction of arrow A to the direction of arrow B in FIG. 2 while the LED lamp 10 is kept mounted on the ceiling or wall surface. Additionally, since the lighting circuit 15 is disposed internally in the cylindrical member 16, the LED lamp 10 can be rendered smaller in size.

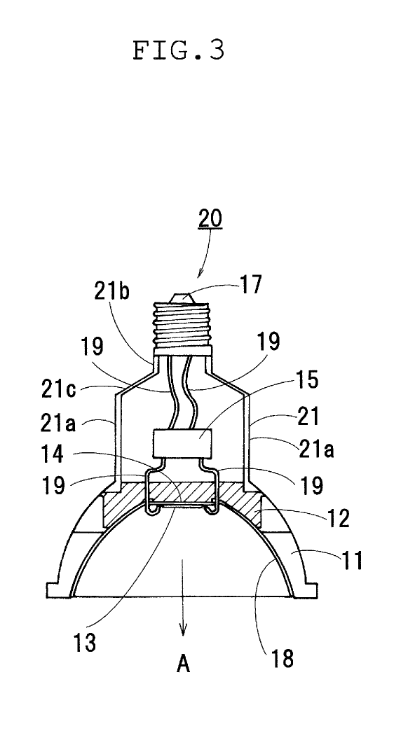

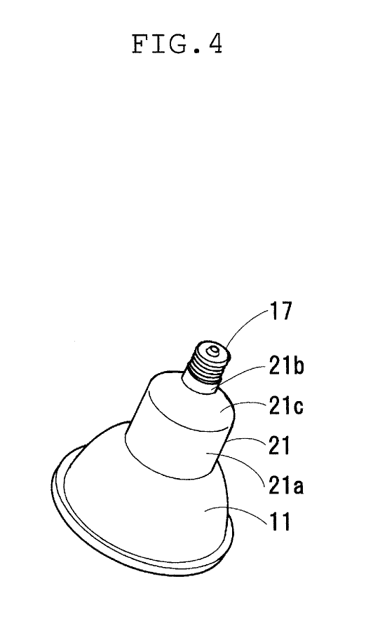

FIGS. 3 and 4 illustrate a second embodiment. The LED lamp 20 of the second embodiment includes a plastic cylindrical member 21 one end of which is attached to the outer periphery of the heat dissipater 12. The cap 17 is connected to the other end of the cylindrical member 21. The lighting circuit 15 is provided internally in the cylindrical member 21. The cylindrical member 21 includes a larger-diameter cylindrical portion 21a, a smaller-diameter cylindrical portion 21b and a tapered ring surface 21c connecting between the larger-diameter and smaller-diameter cylindrical portions 21a and 21b. The larger-diameter cylindrical portion 21a is attached to the outer periphery of the heat dissipater 12, and the cap 17 is connected to the smaller-diameter cylindrical portion 21b.

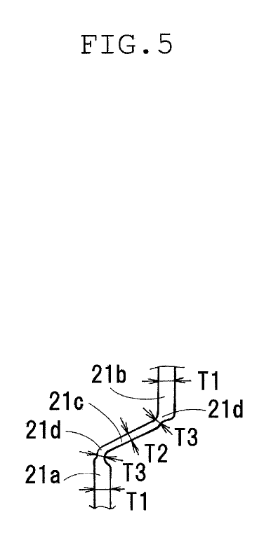

The larger-diameter and smaller-diameter cylindrical portions 21a and 21b have substantially the same thickness T1, and the tapered ring surface 21c has a smaller thickness T2 than the larger-diameter and smaller-diameter cylindrical portions 21a and 21b, as shown in an enlarged view in FIG. 5. A connection between the larger-diameter portion 21a and the tapered ring surface 21c is formed with a flexible portion 21d. A connection between the smaller-diameter portion 21b and the tapered ring surface 21c is also formed with another flexible portion 21d. Both flexible portions 21d have a smaller thickness T3 than the tapered ring surface 21c.

The LED lamp 20 has the same construction as the LED lamp 10 of the above-described first embodiment in the other respects. Accordingly, the identical or similar parts are labeled by the same reference symbols as those in the first embodiment, and the description of these parts will be eliminated.

When the cap 17 is screwed into the socket of the downlight so that the LED lamp 20 thus constructed is mounted, the LED chip 13 is energized to emit light in the direction of arrow A in FIG. 3.

In the state as shown in FIG. 3, the tapered ring surface 21c is flexed at the flexible portion 21d relative to the larger-diameter and smaller-diameter cylindrical portions 21a and 21b such that substantially the entire tapered ring surface 21c is located outside the larger-diameter cylindrical portion 21a. Since the thickness T3 of the flexible portion 21d is smaller than the thickness T2 of the tapered ring surface 21c and the thickness T1 of the larger-diameter cylindrical portion 21a, the tapered ring surface 21c is retained at an extended position as shown in FIG. 3.

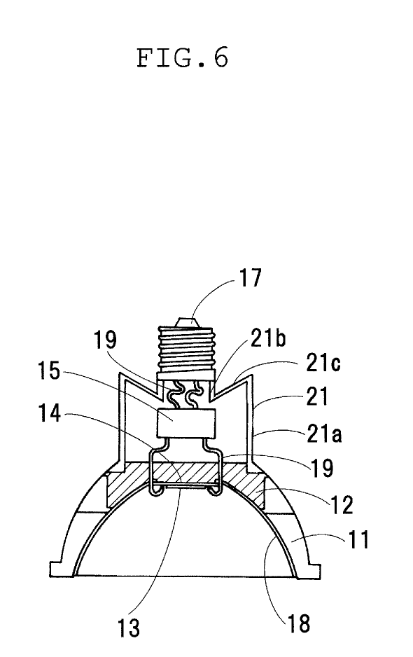

When the cap 11 is pinched by hand to be pushed, the tapered ring surface 21c is flexed at the flexible portion 21d relative to the larger-diameter and smaller-diameter cylindrical portions 21a and 21b, whereupon substantially the entire tapered ring surface 21c is displaced to a contracted position where the tapered ring surface 21c is located inside the larger-diameter cylindrical portion 21a, as shown in FIG. 6. When the hand is detached from the cap 11, the tapered ring surface 21c is retained at the contracted position by the action of the flexible portion 21d. As a result, the lamp length of the LED lamp 20 is reduced.

When the cap 11 is lowered by hand while the tapered ring surface 21c is located at the contracted position, the tapered ring surface 21c is displaced to the extended position where the tapered ring surface 21c is re-located outside the larger-diameter cylindrical portion 21a substantially in its entirety as shown in FIG. 3. As a result, the lamp length is increased.

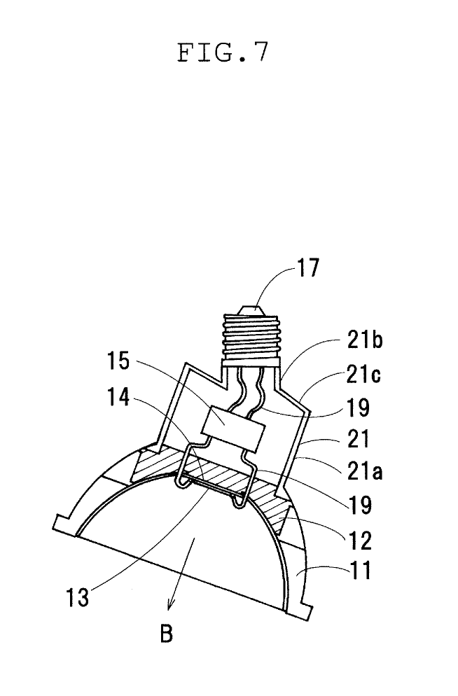

When the cap 11 is pushed or pulled rightward by hand, the tapered ring surface 21c is flexed at the flexible portion 21d relative to the larger-diameter and smaller-diameter cylindrical portions 21a and 21b, whereupon the tapered ring surface 21a is displaced to a flexed position where a right half of the tapered ring surface 21c is located outside the larger-diameter cylindrical portion 21a, while a left half of the tapered ring surface 21c is located inside the larger-diameter cylindrical portion 21a, as shown in FIG. 7. The tapered ring surface 21c is retained at the flexed position by the action of the flexible portion 21d. Consequently, the direction in which the light is emitted by the LED lamp 20 is changed from the arrow A as shown in FIG. 3 to the arrow B as shown in FIG. 7.

When the cap 11 is manually pushed or pulled rightward, the tapered ring surface 21c is displaced to the flexed portion where the left half of the tapered ring surface 21c is located outside the larger-diameter cylindrical portion 21a, while the right half of the tapered ring surface 21c is located inside the larger-diameter cylindrical portion 21a.

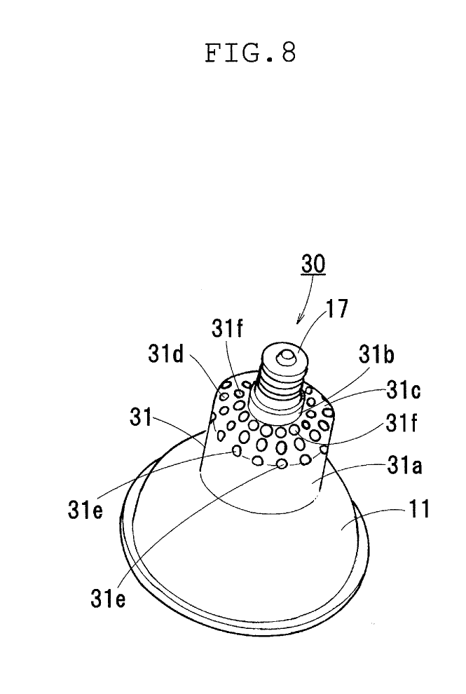

FIG. 8 shows a third embodiment. The LED lamp 30 of the third embodiment includes a cylindrical portion 31 made of plastic. The cylindrical portion 31 includes a larger-diameter cylindrical portion 31a, a smaller-diameter cylindrical portion 31b and a tapered ring surface 31c connecting between the larger-diameter and smaller-diameter cylindrical portions 31a and 31b. The larger-diameter and smaller-diameter cylindrical portions 31a and 31b and the tapered ring surface 31c have substantially the same thickness. The tapered ring surface 31c is formed with a number of generally circular through holes 31d. A connection between the larger-diameter cylindrical portion 31a and the tapered ring surface 31c has through holes 31e formed substantially along the entire circumference of the larger-diameter cylindrical portion 31a at regular intervals. The cylindrical portion 31 includes a part close to a connection between the smaller-diameter cylindrical portion 31b and the tapered ring surface 31c. The part of the cylindrical portion 31 has though holes 31f formed substantially along the entire circumference of the smaller-diameter cylindrical portion 31b at regular intervals.

The LED lamp 30 has the same construction as the LED lamp 20 of the above-described second embodiment in the other respects. Accordingly, the identical or similar parts are labeled by the same reference symbols as those in the second embodiment, and the description of these parts will be eliminated.

Since the tapered ring surface 31c is formed with a number of through holes 31d, 31e and 31f, the surface 31c has a smaller stiffness than the larger-diameter and smaller-diameter cylindrical portions 31a and 31b. As a result, the provision of the through holes 31d to 31f in the third embodiment acts in a manner similar to the provision of the tapered ring surface 21c having a smaller thickness than the larger-diameter and smaller-diameter cylindrical portions 21a and 21b. Furthermore, the through holes 31e and 31f in the third embodiment act in a manner similar to the flexible portion 21d of the LED lamp 20 of the second embodiment. Accordingly, the lamp length can be increased by maintaining the tapered ring surface 31c at the extended position in the LED lamp 30 of the third embodiment in the same manner as in the LED lamp 20 of the second embodiment. The lamp length can be reduced by maintaining the tapered ring surface 31c at the contracted position. Furthermore, the radiation direction of the LED lamp 30 can be changed by maintaining the tapered ring surface 31c at the flexed position.

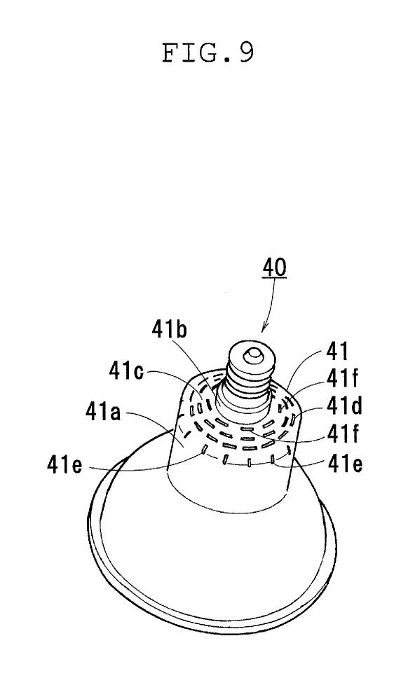

FIG. 9 shows a fourth embodiment. The LED lamp 40 of the fourth embodiment includes a cylindrical portion 41 further including a larger-diameter cylindrical portion 41a, a smaller-diameter cylindrical portion 41b and a tapered ring surface 41c connecting between the larger-diameter and smaller-diameter cylindrical portions 41a and 41b. The tapered ring surface 41c has rectangular through holes 41d in the fourth embodiment although the tapered ring surface 31c has the circular through holes 31d to 31f in the third embodiment. The connection between the larger-diameter cylindrical portion 41a and the tapered ring surface 41c is formed with a through hole 41e, and the connection between the smaller-diameter cylindrical portion 41c is formed with a through hole 41f, in the same manner as in the third embodiment. As a result, the tapered ring surface 41c can selectively be retained at the extended position, the reduced position or the flexed position.

The LED lamp 40 has the same construction as the LED lamp 20 of the above-described second embodiment in the other respects. Accordingly, the identical or similar parts are labeled by the same reference symbols as those in the second embodiment, and the description of these parts will be eliminated.

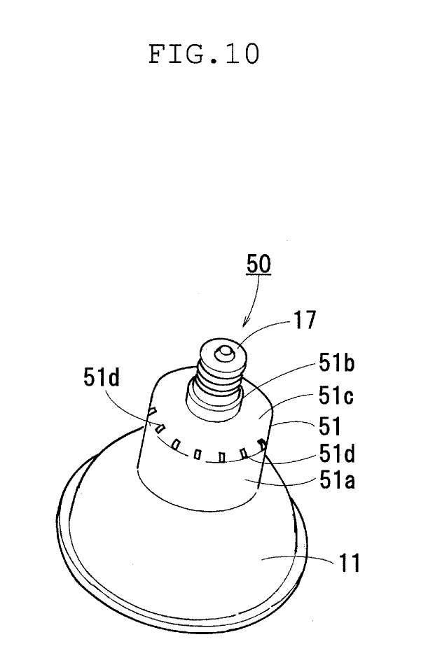

FIG. 10 shows a fifth embodiment. The LED lamp 50 of the fifth embodiment includes a cylindrical portion 51 further including a larger-diameter cylindrical portion 51a, a smaller-diameter cylindrical portion 51b and a tapered ring surface 51c connecting between the larger-diameter and smaller-diameter cylindrical portions 51a and 51b. A connection between the larger-diameter cylindrical portion and the tapered ring surface 51c has rectangular through holes 51d formed substantially along the entire circumference of the larger-diameter cylindrical portion 51a.

The LED lamp 50 has the same construction as the LED lamp 20 of the above-described second embodiment in the other respects. Accordingly, the identical or similar parts are labeled by the same reference symbols as those in the second embodiment, and the description of these parts will be eliminated.

The though holes 51d in the fifth embodiment acts in a similar manner as the flexible portion 21d in the second embodiment. Accordingly, the tapered ring surface 51 is flexed at the through holes 51d relative to the larger-diameter and smaller-diameter cylindrical portions 51a and 51b, whereupon the tapered ring surface 51c can be displaced to the extended portion, the contracted position or the flexed position.

Although the through holes 31d, 31e, 31f, 41d, 41e, 41f and 51d are provided in the third, fourth and fifth embodiments respectively, slits can act in a manner similar to these through holes 31d, 31e, 31f, 41d, 41e, 41f and 51d.

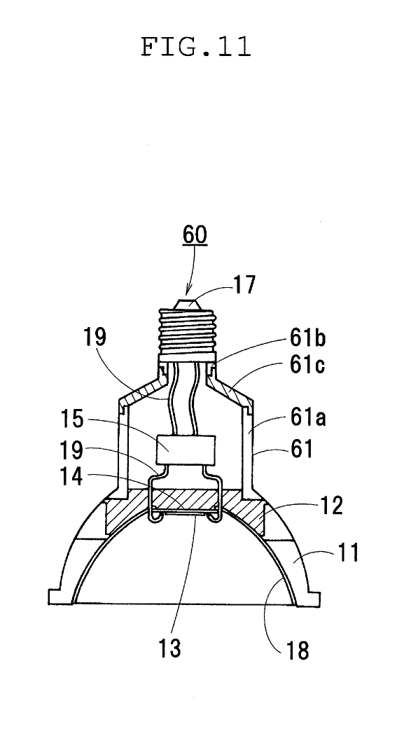

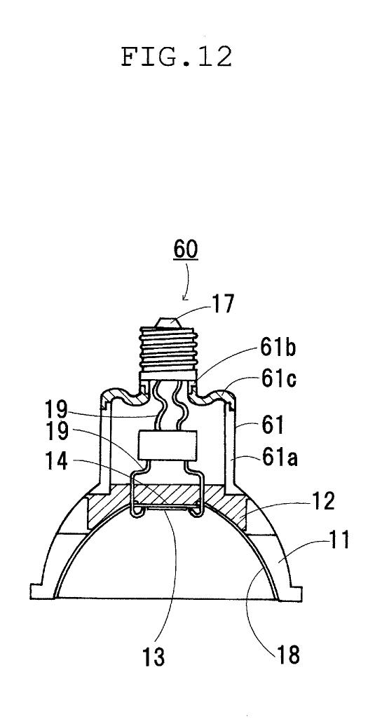

FIGS. 11 and 12 show a sixth embodiment. The LED lamp 60 of the sixth embodiment includes a cylindrical portion 61 further including a larger-diameter cylindrical portion 61a, a smaller-diameter cylindrical portion 61b and a tapered ring surface 61c connecting between the larger-diameter and smaller-diameter cylindrical portions 61a and 61b. The tapered ring surface 61c is made of plastic that is more flexible than those of the larger-diameter and smaller-diameter cylindrical portions 61a and 61b.

The LED lamp 60 has the same construction as the LED lamp 20 of the above-described second embodiment in the other respects. Accordingly, the identical or similar parts are labeled by the same reference symbols as those in the second embodiment, and the description of these parts will be eliminated.

The tapered ring surface 61c more flexible than the larger-diameter and smaller-diameter cylindrical portions 61a and 61b is flexed into a wavy shape in the sixth embodiment, whereupon the tapered ring surface can be displaced from the extended position as shown in FIG. 11 to the contracted position as shown in FIG. 12.

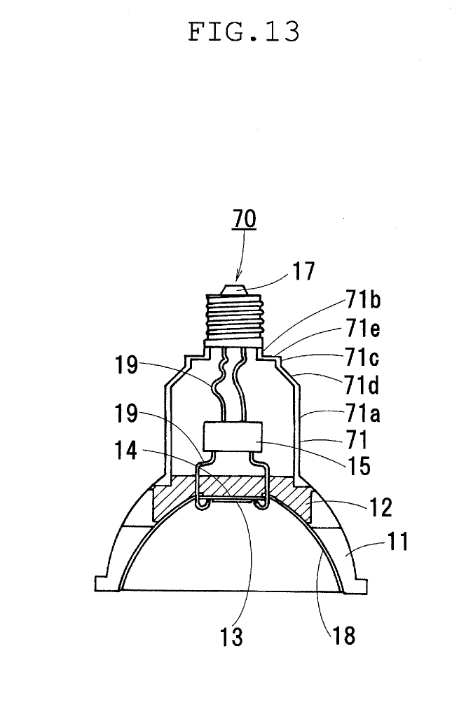

FIGS. 13 to 15nd 14 show a seventh embodiment. The LED lamp 70 of the seventh embodiment includes a cylindrical member 71 made of plastic. The cylindrical member 71 includes a larger-diameter cylindrical portion 71a connected to the heat dissipator 12, a smaller-diameter cylindrical portion 71b connected to the cap 17, a medium-diameter cylindrical portion 71c provided between the larger-diameter and smaller-diameter cylindrical portions 71a and 71b, a tapered ring surface 71d connecting between the larger-diameter and medium-diameter cylindrical portions 71a and 71c, and a ring surface 71e connecting between the medium-diameter cylindrical portion 71d and the smaller-diameter cylindrical portion 71b.

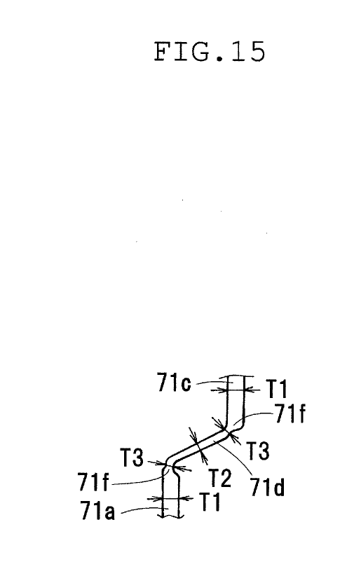

The larger-, smaller- and medium-diameter cylindrical portions 71a, 71b and 71c have substantially the same thickness T1. The tapered ring surface 71d has a smaller thickness T2 than the larger-, smaller- and medium-diameter cylindrical portions 71a, 71b and 71c. A connection between the larger-diameter cylindrical portion 71a and the tapered ring surface 71d is formed with a flexible portion 71f as shown in an expanded form in FIG. 15. A connection between the medium-diameter cylindrical portion 71c and the tapered ring surface 71d is also formed with a flexible portion 71f. Each flexible portion 71f has a smaller thickness T3 than the tapered ring surface 71d.

The LED lamp 70 has the same construction as the LED lamp 20 of the above-described second embodiment in the other respects. Accordingly, the identical or similar parts are labeled by the same reference symbols as those in the second embodiment, and the description of these parts will be eliminated.

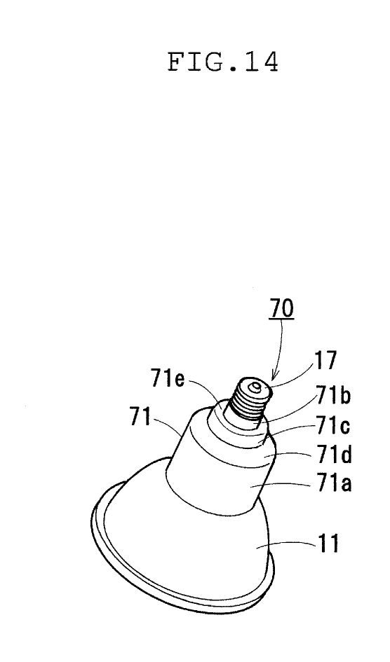

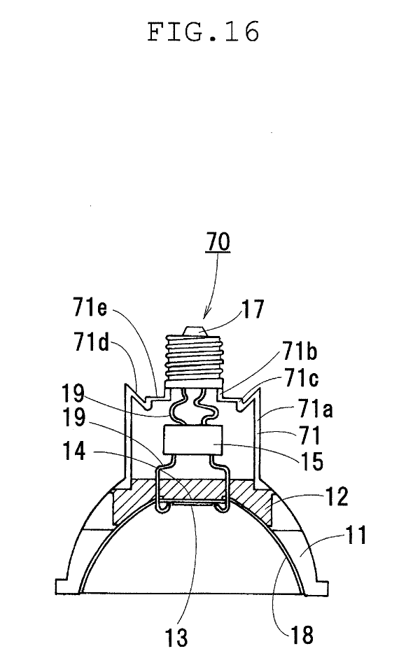

The tapered ring surface 71d is flexed at the flexible portions 71f relative to the larger- and medium-diameter cylindrical portions 71a and 71c, so that the tapered ring surface 71d is selectively retained at any one of an extended position where substantially the entire tapered ring surface 71d is located outside the larger-diameter cylindrical portion 71a as shown in FIGS. 13 and 14, an contracted portion where substantially the entire tapered ring surface 71d is located inside the larger-diameter cylindrical portion 71a as shown in FIG. 16, and a flexed position where one of right and left halves of the tapered ring surface 71d is located outside the larger-diameter cylindrical portion 71a and the other half of the tapered ring surface 71d is located inside the larger-diameter cylindrical portion 71a.

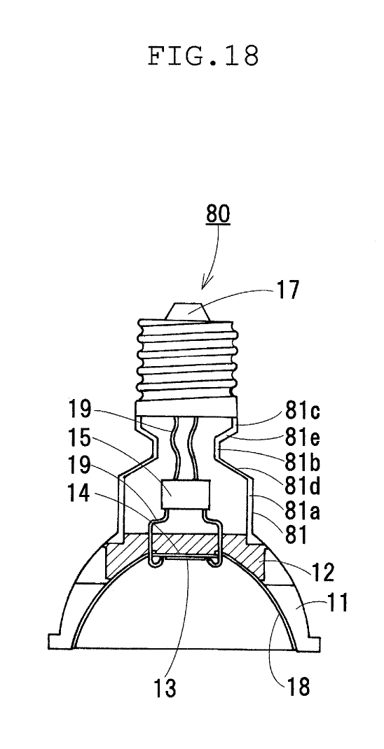

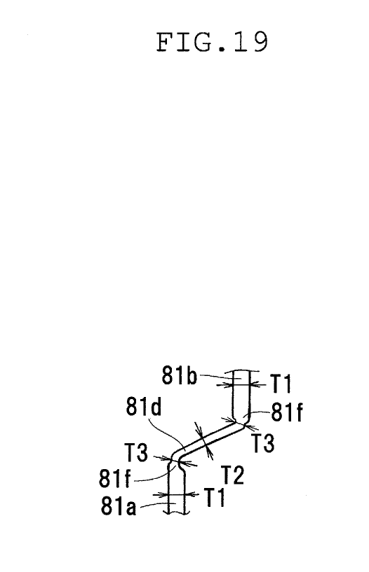

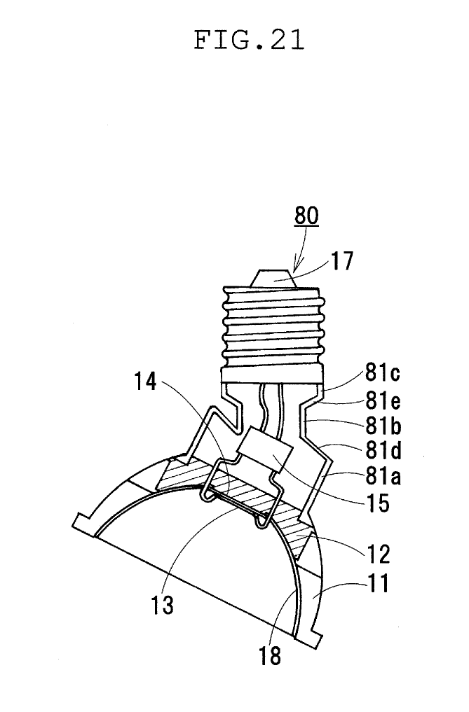

FIGS. 18 to 21 show an eighth embodiment. The LED lamp 80 of the eighth embodiment includes a cylindrical member 81 made of plastic. The cylindrical member 81 includes a larger-diameter cylindrical portion 81a connected to the heat dissipator 12, a smaller-diameter cylindrical portion 81b, a medium-diameter cylindrical portion 81c connected to the cap 17, a first tapered ring surface 81d connecting between the larger-diameter and smaller-diameter cylindrical portions 81a and 81b, and a second tapered ring surface 81e connecting between the smaller- and medium-diameter cylindrical portions 81b and 81c.

The larger-, smaller- and medium-diameter cylindrical portions 81a, 81b and 81c and the second tapered ring surface 81e have substantially the same thickness T1. The first tapered ring surface 81d has a smaller thickness T2 than the larger-, smaller- and medium-diameter cylindrical portions 81a, 81b and 81c and the second tapered ring surface 81e. Furthermore, a connection between the larger-diameter cylindrical portion 81a and the first tapered ring surface 81d is formed with a flexible portion 81f. A connection between the smaller-diameter cylindrical portion 81b and the first tapered ring surface 81d is also formed with a flexible portion 81f. Each flexible portion 81f has a smaller thickness T3 than the first tapered ring surface 81d.

The LED lamp 80 has the same construction as the LED lamp 20 of the above-described second embodiment in the other respects. Accordingly, the identical or similar parts are labeled by the same reference symbols as those in the second embodiment, and the description of these parts will be eliminated.

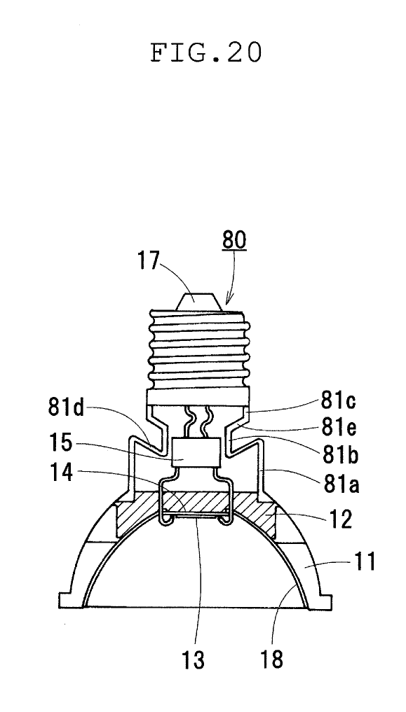

The first tapered ring surface 81d is flexed at the flexible portions 81f relative to the larger- and smaller-diameter cylindrical portions 81a and 81b, so that the first tapered ring surface 81d is selectively retained at any one of an extended position where substantially the entire first tapered ring surface 81d is located outside the larger-diameter cylindrical portion 81a as shown in FIG. 18, an contracted portion where substantially the entire first tapered ring surface 81d is located inside the larger-diameter cylindrical portion 81a as shown in FIG. 20, and a flexed position where one of right and left halves of the first tapered ring surface 81d is located outside the larger-diameter cylindrical portion 71a and the other half of the first tapered ring surface 81d is located inside the larger-diameter cylindrical portion 81a.

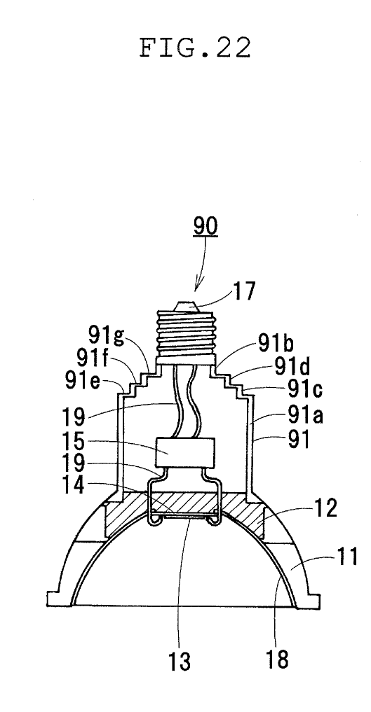

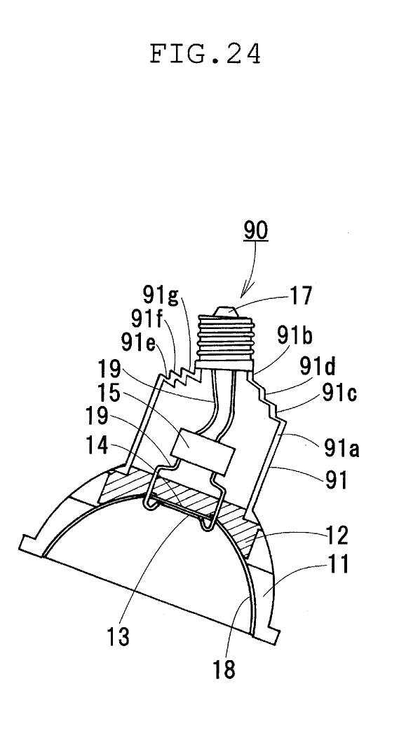

FIGS. 22 to 24 show a ninth embodiment. The LED lamp 90 of the ninth embodiment includes a cylindrical member 91 made of plastic. The cylindrical member 91 includes a larger-diameter cylindrical portion 91a connected to the heat dissipator 12, a smaller-diameter cylindrical portion 91b connected to the cap 17, and a plurality of medium-diameter cylindrical portions 91c and 91d having different diameters. The medium-diameter cylindrical portions 91c and 91d are arranged between the larger- and smaller-diameter cylindrical portions 91a and 91b so that the diameters of the medium-diameter cylindrical portions are sequentially reduced from the larger-diameter cylindrical portion 91a side to the smaller-diameter cylindrical portion 91b side. The cylindrical portions 91a, 91b, 91c and 91d all adjacent to one another are connected by the ring surfaces 91e, 91f and 91g respectively. Each one of the ring surfaces 91e, 91f and 91g is made of a material that is more flexible than the materials of the larger-, smaller- and medium-diameter cylindrical portions 91a, 91b, 91c and 91d. Alternatively, each one of the ring surfaces 91e, 91f and 91g has a smaller thickness than the larger-, smaller- and medium-diameter cylindrical portions 91a, 91b, 91c and 91d.

The LED lamp 90 has the same construction as the LED lamp 20 of the above-described second embodiment in the other respects. Accordingly, the identical or similar parts are labeled by the same reference symbols as those in the second embodiment, and the description of these parts will be eliminated.

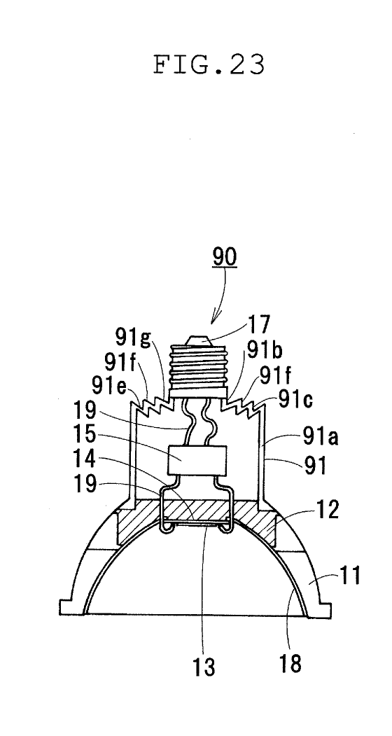

When the ring surfaces 91e, 91f and 91g which are more flexible or thinner than the larger-, smaller- and medium-diameter cylindrical portions 91a, 91b, 91c and 91d are flexed, the ring surfaces 91e, 91f and 91g can be displaced to any one of an extended position where substantially the entire ring surfaces 91e, 91f and 91g are located outside the larger-diameter cylindrical portion 91a as shown in FIG. 22, a contracted position where substantially the entire ring surfaces 91e, 91f and 91g are located inside the larger-diameter cylindrical portion 91a as shown in FIG. 23 and a flexed position where ones of right and left halves of the ring surfaces 91e, 91f and 91g are located outside the larger-diameter cylindrical portion 91a and the other halves of the ring surface 91e, 91f and 91g are located inside the larger-diameter cylindrical portion 91a.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An LED lamp comprising:
a heat dissipator having two ends;
a module substrate fixed to one end of the heat dissipator and mounted with an LED chip;
a cap mounted on the other end side of the heat dissipator;
a lighting circuit provided between the module substrate and the cap to supply electric power to the LED chip, the lighting circuit being electrically connected to the cap; and
a cylindrical member which is interposed between the heat dissipator and the cap and is flexible so that the heat dissipator is tiltable relative to the cap.

2. An LED lamp comprising:
a heat dissipator having two ends;
a module substrate fixed to one end of the heat dissipator and mounted with an LED chip;
a cap mounted on the other end side of the heat dissipator;
a lighting circuit provided between the module substrate and the cap to supply electric power to the LED chip, the lighting circuit being electrically connected to the cap; and
a cylindrical member which is interposed between the heat dissipator and the cap and is extendable so that the heat dissipator is capable of advancing or retreating relative to the cap.

3. The LED lamp according to claim 1, wherein the lighting circuit is disposed internally in the cylindrical member.

4. The LED lamp according to claim 2, wherein the lighting circuit is disposed internally in the cylindrical member.

5. The LED lamp according to claim 1, wherein the cylindrical member includes a middle portion formed with bellows and has two ends one of which is connected to the heat dissipator and the other of which is connected to the cap.

6. The LED lamp according to claim 2, wherein the cylindrical member includes a middle portion formed with bellows and has two ends one of which is connected to the heat dissipator and the other of which is connected to the cap.

7. The LED lamp according to claim 3, wherein the cylindrical member includes a middle portion formed with bellows and has two ends one of which is connected to the heat dissipator and the other of which is connected to the cap.

8. The LED lamp according to claim 4, wherein the cylindrical member includes a middle portion formed with bellows and has two ends one of which is connected to the heat dissipator and the other of which is connected to the cap.

9. The LED lamp according to claim 1, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the connection between the large-diameter cylindrical portion and the tapered ring surface is formed with a first flexible portion, and the connection between the smaller-diameter cylindrical portion and the tapered ring surface is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

10. The LED lamp according to claim 2, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the connection between the large-diameter cylindrical portion and the tapered ring surface is formed with a first flexible portion, and the connection between the smaller-diameter cylindrical portion and the tapered ring surface is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

11. The LED lamp according to claim 3, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the connection between the large-diameter cylindrical portion and the tapered ring surface is formed with a first flexible portion, and the connection between the smaller-diameter cylindrical portion and the tapered ring surface is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

12. The LED lamp according to claim 4, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the connection between the large-diameter cylindrical portion and the tapered ring surface is formed with a first flexible portion, and the connection between the smaller-diameter cylindrical portion and the tapered ring surface is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

13. The LED lamp according to claim 1, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface is formed with a plurality of though holes or slits; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

14. The LED lamp according to claim 2, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface is formed with a plurality of though holes or slits; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

15. The LED lamp according to claim 3, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface is formed with a plurality of though holes or slits; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

16. The LED lamp according to claim 4, wherein the cylindrical member includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface is formed with a plurality of though holes or slits; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

17. The LED lamp according to claim 1, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface has a smaller thickness than the lager-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

18. The LED lamp according to claim 2, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface has a smaller thickness than the lager-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

19. The LED lamp according to claim 3, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface has a smaller thickness than the lager-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

20. The LED lamp according to claim 4, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the tapered ring surface has a smaller thickness than the lager-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

21. The LED lamp according to claim 1, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the plastic material formed into the tapered ring surface is more flexible than the plastic material formed into the larger-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

22. The LED lamp according to claim 2, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the plastic material formed into the tapered ring surface is more flexible than the plastic material formed into the larger-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

23. The LED lamp according to claim 3, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the plastic material formed into the tapered ring surface is more flexible than the plastic material formed into the larger-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

24. The LED lamp according to claim 4, wherein the cylindrical member is formed of a plastic material and includes a larger-diameter cylindrical portion connectable to the heat dissipator, a smaller-diameter cylindrical portion connectable to the cap and a tapered ring surface connecting between the larger-diameter and smaller-diameter cylindrical portions;
the plastic material formed into the tapered ring surface is more flexible than the plastic material formed into the larger-diameter and smaller-diameter cylindrical portions; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

25. The LED lamp according to claim 1, wherein the cylindrical member includes a larger-diameter cylindrical portion connectable to the heat dissipator, a medium-diameter cylindrical portion, a smaller-diameter cylindrical portion connectable to the cap, a tapered ring surface connecting between the larger-diameter cylindrical portion and the medium-diameter cylindrical portion and a ring surface connecting between the medium-diameter cylindrical portion and the smaller-diameter cylindrical portion;
the connection between the larger-diameter cylindrical portion and the tapered ring surface is formed with a first flexible portion, and the connection between the tapered ring surface and the smaller-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

26. The LED lamp according to claim 2, wherein the cylindrical member includes a larger-diameter cylindrical portion connectable to the heat dissipator, a medium-diameter cylindrical portion, a smaller-diameter cylindrical portion connectable to the cap, a tapered ring surface connecting between the larger-diameter cylindrical portion and the medium-diameter cylindrical portion and a ring surface connecting between the medium-diameter cylindrical portion and the smaller-diameter cylindrical portion;
the connection between the larger-diameter cylindrical portion and the tapered ring surface is formed with a first flexible portion, and the connection between the tapered ring surface and the smaller-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

27. The LED lamp according to claim 3, wherein the cylindrical member includes a larger-diameter cylindrical portion connectable to the heat dissipator, a medium-diameter cylindrical portion, a smaller-diameter cylindrical portion connectable to the cap, a tapered ring surface connecting between the larger-diameter cylindrical portion and the medium-diameter cylindrical portion and a ring surface connecting between the medium-diameter cylindrical portion and the smaller-diameter cylindrical portion;
the connection between the larger-diameter cylindrical portion and the tapered ring surface is formed with a first flexible portion, and the connection between the tapered ring surface and the smaller-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

28. The LED lamp according to claim 4, wherein the cylindrical member includes a larger-diameter cylindrical portion connectable to the heat dissipator, a medium-diameter cylindrical portion, a smaller-diameter cylindrical portion connectable to the cap, a tapered ring surface connecting between the larger-diameter cylindrical portion and the medium-diameter cylindrical portion and a ring surface connecting between the medium-diameter cylindrical portion and the smaller-diameter cylindrical portion;
the connection between the larger-diameter cylindrical portion and the tapered ring surface is formed with a first flexible portion, and the connection between the tapered ring surface and the smaller-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

29. The LED lamp according to claim 1, wherein the cylindrical member includes a larger-diameter cylindrical portion connectable to the heat dissipator, a smaller-diameter cylindrical portion, a medium-diameter cylindrical portion connectable to the cap, a tapered ring surface connecting between the larger-diameter and smaller-diameter cylindrical portions, and a ring surface connecting between the smaller-diameter cylindrical portion and the medium-diameter cylindrical portion;
the connection between the larger-diameter cylindrical portion and the tapered ring surface is formed with a first flexible portion, and the connection between the smaller-diameter cylindrical portion and the medium-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

30. The LED lamp according to claim 2, wherein the cylindrical member includes a larger-diameter cylindrical portion connectable to the heat dissipator, a smaller-diameter cylindrical portion, a medium-diameter cylindrical portion connectable to the cap, a tapered ring surface connecting between the larger-diameter and smaller-diameter cylindrical portions, and a ring surface connecting between the smaller-diameter cylindrical portion and the medium-diameter cylindrical portion;
the connection between the larger-diameter cylindrical portion and the tapered ring surface is formed with a first flexible portion, and the connection between the smaller-diameter cylindrical portion and the medium-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

31. The LED lamp according to claim 3, wherein the cylindrical member includes a larger-diameter cylindrical portion connectable to the heat dissipator, a smaller-diameter cylindrical portion, a medium-diameter cylindrical portion connectable to the cap, a tapered ring surface connecting between the larger-diameter and smaller-diameter cylindrical portions, and a ring surface connecting between the smaller-diameter cylindrical portion and the medium-diameter cylindrical portion;
the connection between the larger-diameter cylindrical portion and the tapered ring surface is formed with a first flexible portion, and the connection between the smaller-diameter cylindrical portion and the medium-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

32. The LED lamp according to claim 4, wherein the cylindrical member includes a larger-diameter cylindrical portion connectable to the heat dissipator, a smaller-diameter cylindrical portion, a medium-diameter cylindrical portion connectable to the cap, a tapered ring surface connecting between the larger-diameter and smaller-diameter cylindrical portions, and a ring surface connecting between the smaller-diameter cylindrical portion and the medium-diameter cylindrical portion;
the connection between the larger-diameter cylindrical portion and the tapered ring surface is formed with a first flexible portion, and the connection between the smaller-diameter cylindrical portion and the medium-diameter cylindrical portion is formed with a second flexible portion; and
the tapered ring surface is flexed at the flexible portion relative to the larger-diameter and smaller-diameter cylindrical portions thereby to be selectively retained at any one of an extended position where the tapered ring surface is located outside the larger-diameter portion in substantial entirety thereof, a contracted position where the tapered ring surface is located inside the larger-diameter cylindrical portion and a flexed position where either one of right and left halves of the tapered ring surface is located outside the larger-diameter cylindrical portion and the other half of the tapered ring surface is located inside the larger-diameter cylindrical portion.

33. The LED lamp according to claim 1, wherein the cylindrical member is formed of a plastic material and includes a larger-diameter cylindrical portion connectable to the heat dissipator, a smaller-diameter cylindrical portion connectable to the cap and a plurality of medium-diameter cylindrical portions having different diameters and arranged between the large- and smaller-diameter cylindrical portions so that diameters of the medium-diameter cylindrical portions are sequentially reduced from the larger-diameter cylindrical portion side to the smaller-diameter cylindrical portion side, and ring surfaces connecting between the cylindrical portions all adjacent to one another;
each one of the ring surfaces is made of a material that is more flexible than materials of the larger-, smaller- and medium-diameter cylindrical portions; and
the ring surfaces are flexed relative to the larger-, medium- and smaller-diameter cylindrical portions thereby to be selectively retained at any one of an extended position where the ring surfaces are located outside the larger-diameter portion in their substantial entireties, a contracted position where the ring surfaces are located inside the larger-diameter cylindrical portion and a flexed position where either one of right and left halves of the ring surfaces are located outside the larger-diameter cylindrical portion and the other halves of the ring surfaces are located inside the larger-diameter cylindrical portion.

34. The LED lamp according to claim 2, wherein the cylindrical member is formed of a plastic material and includes a larger-diameter cylindrical portion connectable to the heat dissipator, a smaller-diameter cylindrical portion connectable to the cap and a plurality of medium-diameter cylindrical portions having different diameters and arranged between the large- and smaller-diameter cylindrical portions so that diameters of the medium-diameter cylindrical portions are sequentially reduced from the larger-diameter cylindrical portion side to the smaller-diameter cylindrical portion side, and ring surfaces connecting between the cylindrical portions all adjacent to one another;
each one of the ring surfaces is made of a material that is more flexible than materials of the larger-, smaller- and medium-diameter cylindrical portions; and
the ring surfaces are flexed relative to the larger-, medium- and smaller-diameter cylindrical portions thereby to be selectively retained at any one of an extended position where the ring surfaces are located outside the larger-diameter portion in their substantial entireties, a contracted position where the ring surfaces are located inside the larger-diameter cylindrical portion and a flexed position where either one of right and left halves of the ring surfaces are located outside the larger-diameter cylindrical portion and the other halves of the ring surfaces are located inside the larger-diameter cylindrical portion.

35. The LED lamp according to claim 3, wherein the cylindrical member is formed of a plastic material and includes a larger-diameter cylindrical portion connectable to the heat dissipator, a smaller-diameter cylindrical portion connectable to the cap and a plurality of medium-diameter cylindrical portions having different diameters and arranged between the large- and smaller-diameter cylindrical portions so that diameters of the medium-diameter cylindrical portions are sequentially reduced from the larger-diameter cylindrical portion side to the smaller-diameter cylindrical portion side, and ring surfaces connecting between the cylindrical portions all adjacent to one another;
each one of the ring surfaces is made of a material that is more flexible than materials of the larger-, smaller- and medium-diameter cylindrical portions; and
the ring surfaces are flexed relative to the larger-, medium- and smaller-diameter cylindrical portions thereby to be selectively retained at any one of an extended position where the ring surfaces are located outside the larger-diameter portion in their substantial entireties, a contracted position where the ring surfaces are located inside the larger-diameter cylindrical portion and a flexed position where either one of right and left halves of the ring surfaces are located outside the larger-diameter cylindrical portion and the other halves of the ring surfaces are located inside the larger-diameter cylindrical portion.

36. The LED lamp according to claim 4, wherein the cylindrical member is formed of a plastic material and includes a larger-diameter cylindrical portion connectable to the heat dissipator, a smaller-diameter cylindrical portion connectable to the cap and a plurality of medium-diameter cylindrical portions having different diameters and arranged between the large- and smaller-diameter cylindrical portions so that diameters of the medium-diameter cylindrical portions are sequentially reduced from the larger-diameter cylindrical portion side to the smaller-diameter cylindrical portion side, and ring surfaces connecting between the cylindrical portions all adjacent to one another;
each one of the ring surfaces is made of a material that is more flexible than materials of the larger-, smaller- and medium-diameter cylindrical portions; and
the ring surfaces are flexed relative to the larger-, medium- and smaller-diameter cylindrical portions thereby to be selectively retained at any one of an extended position where the ring surfaces are located outside the larger-diameter portion in their substantial entireties, a contracted position where the ring surfaces are located inside the larger-diameter cylindrical portion and a flexed position where either one of right and left halves of the ring surfaces are located outside the larger-diameter cylindrical portion and the other halves of the ring surfaces are located inside the larger-diameter cylindrical portion.
